(19) United States
(12) Patent Application Publication
(10) Pub. No.: US 2012/0315615 A1
(43) Pub. Date: Dec. 13, 2012

(54) MULTI-SENSORY METHOD FOR LEARNING NAMES

(75) Inventor: Dennis Hilker, Owings, MD (US)

(73) Assignee: HEALTH AND HAPPINESS, LLC, Owings, MD (US)

(21) Appl. No.: 13/531,741

(22) Filed: Jun. 25, 2012

Related U.S. Application Data
(63) Continuation-in-part of application No. 12/749,643, filed on Mar. 30, 2010.

(51) Int. Cl. G09B 5/00

(52) U.S. Cl. 434/309

(57) ABSTRACT

A method for assisting individuals with learning the names of others is characterized by the display and recognition of information relating to the person whose name is to be learned. Such information is stored in a database and then provided incrementally to the person who is trying to learn the names. The person is prompted to identify a selected individual from other individuals and an indication is provided when the person correctly identifies the selected individual. The method is particularly suitable for teachers seeking to learn the names of their students, for businesses seeking to learn the names of their customers and for organizations seeking to learn the names of their members.

This application is a continuation-in-part of application Ser. No. 12/749,643 filed Mar. 30, 2010.

### BACKGROUND OF THE INVENTION

Face to face communication in human relationships has always required the learning of names and social information so that a new person can understand the social structure and can succeed in making friends and finding a job. Some cultures have had very structured and rigorous procedures for introducing new people with elaborate stating of names and social or governmental titles. Such formal introduction procedures are still somewhat common when a new leader is introduced to a group of employees. If there isn't a job related hierarchy, then the introductions are usually short and given quickly in a context of other kinds of information. If someone is trying to remember the twenty new names of people they just met at a business meeting, it is not easy and it can be very frustrating. The person may write down the new names they are learning and they may say a new person's name at different times in conversation in order to practice the physical expression and hear the person's name while the person is visually present. If a staff person meets twenty new customers per day and does not have a way for easily reviewing the information, then it is unlikely that the staff person will remember but a few of the new customers.

For two centuries royalty and business people exchanged paper cards with their personal name, court or job title, and court or business name and address printed on the card. These cards were exchanged as a reliable and durable way of giving and retaining social identity information. Then business cards began to contain telephone numbers and now some business cards will have a facial photograph, photograph of a business building, and a website or email address. However, people do not exchange business or personal cards very often today and the cards do not facilitate customers and school personnel learning each other's name. Sometimes people will write down their name and phone number to exchange with some people they meet, but name cards are now only exchanged by business or professional service people with their peers or their clients.

Sometimes teachers take the school yearbooks and copy the student and staff pictures. Then the teachers cut the photos with student names into small pieces of paper. The teachers hold the photo card with one finger covering the name and then try to guess the student's name. Then they quickly move their finger and see if they had correctly remembered the student's name. They also put the photo cards on a large drawing of their classroom with the student seats. Then they are able to include the face photo, the student name and the student's assigned seat as a basis for playing card sorting games. These techniques were very time consuming and only the very dedicated teachers will take the time and give the effort to learn students' names using school yearbook photographs.

The sound of a person's voice and the visual patterns of the person's face when they say their name are very unique. The old camera equipment necessary to make a film movie or videotape of people introducing themselves was large, required electrical wiring, and the sound/video recording equipment was complex and heavy.

### SUMMARY OF THE INVENTION

Newer smartphones allow instant recording, playback, storage, transfer and improvement of colorful motion pictures of people saying their name, job, home location or other basic information. This information can be easily uploaded to the new phone processing computer systems that are all integrated for digital text and voice communication. The smartphones allow users to take motion pictures with high quality visual and sound storage. The smartphone users can pull up the recorded personal information, either from their own smartphone or from their phone company computer information system. So, whenever they have some spare time, the smartphone users will be able to easily review the names, jobs, and home locations of other smartphone users in order to easily recognize other users and have useful conversations.

Usually, people who are seeking some assistance in a school, store, or government office will approach the people who appear to be staff and the staff person will make eye contact and express a welcoming response (“Good morning. I am Tom. How can I help you?”). Then the person will say their name and their reason for coming to the organization. If the person wants to shop in a store or get to know a library in order to use its materials, then the welcoming person can ask if the visitor would be willing to allow someone to make a brief video recording of their personal information that would allow the building staff to learn their name and their general interests in using their store, library, etc. If the person is interested, the staff person could display some of the staff video introduction recordings by using a smartphone or a laptop for displaying the organization's customer information website. The staff person could demonstrate how the person could give their permission for allowing their video introduction recording to be seen by the staff and by other visitors, allowing the person to have a much more friendly and comfortable visit to the store in the future. If the person agrees to the video recording procedure, then the staff person may ask for their permission to correctly type in their first name and last name into the smartphone. Then the staff person would advise the visitor where to stand, how to look into the video recorder and how to say their first and name, say what kind of job they pursue, why they come to the store/library and what is the neighborhood or city area of their home. The staff person would show the video recording to the visitor and explain how the visitor can set the limits for which staff members or other visitors would be given access to their video self-introduction that will be stored in the store's customer information database. The customer would be given a brochure that would explain how they may send text messages to the smartphone central computer system to give access to the video introduction to others or remove their information from access by groups of employees or other customers.

Face to face communication is the most trusted way of exchanging information. Learning each other's name is a basic way of building a social knowledge of each other that could in some way promote helping each other or simply enjoying some time together. However, learning to recognize faces and voices with remembering names and social information is a demanding process. A colorful motion recording of a person saying their name and saying some personal information (job position, home area, etc.) is the most attractive and powerful combination of information for learning people's names. The new smartphone can record the information and allow the phone user to review the recent people who have been added to their group of people whose names or jobs and home locations are being memorized. Each person can select the type of information and review games available from the smartphone central office computer system that would be the most entertaining and effective in increasing their memory of new people they have met.

To learn and remember the identity of people, it is important to record and re-experience the sight of the person's face while they say their name, say what kind of job they pursue, and what city or neighborhood they live in. Their facial expression, tone of voice and body posture will express how relaxed or tense they may be, how happy or depressed they may feel, and how motivated or reluctant they are in meeting new people. Many people are concerned about putting personal information into Internet accessible systems where strangers could access the photo information, distort it and put it in a public display for embarrassment. The most immediate and realistic evidence of the smartphone system's safety is for the customer or the parent of a student to actually see how the system records and displays the information for people to share and learn the names and social information of other people. The requirements for passwords and permission verification would be present in all forms of information being recorded and accessed by the smartphone system.

The most effective stimulus procedure for learning names is to see and hear the person say their own name, their job and their home location. The tone of voice, the facial expressions, and the posture/head alignment are unique for each individual. Smartphones allow a person to see the initial recording and decide when they might want to record another version with different clothing, at a different time of day, or with some other changes. An interested person would view the website at the store or school and see the brief video explaining that human beings learn and remember people's names and personal information in connection with visual, audible, and social information. The smartphones upload the information to a website designed to safely store and protect the information, while also downloading the information to licensed users with controlled passwords through which the users learn the face/name recognition and memory of job/home information through engaging activities presented on the smartphones. The video explains that anyone desiring to use the website to learn names of other people would need to upload and provide permission for the website to safely record a video recording of their face, an audio recording of them saying their name, and some social information entered via a keyboard or keypad. Smartphone users often have their phone within easy grasp and use, so that they could use their phone to review new names while waiting for a bus or eating some lunch.

Another benefit is that a person who is going to shop in a favorite store could use their smartphone to pull up all of the employee data and review the staff workers names, jobs in the store, and their home data. By reviewing the staff data the person could decide on which staff members they would most want to get help from in the store. A parent going to the school of one of their children might want to review the name of their child's teacher and location of their classroom.

The stored information is preferably the motion picture of each person saying their name, their job, and their home location. It is stored in a secure environment that is password protected and accessible by a smartphone accessible wireless electronic network.

### BRIEF DESCRIPTION OF THE FIGURES

FIG. 1 is a block diagram of a system for storing and retrieving information using the method according to the invention;

FIG. 2 is a block diagram of the steps for accessing the system of FIG. 1;

FIG. 3 is a block diagram of the steps according to the name learning method according to the invention; and

FIGS. 4a-c are representations of a smartphone for storing information in the system of FIG. 1.

### DETAILED DESCRIPTION

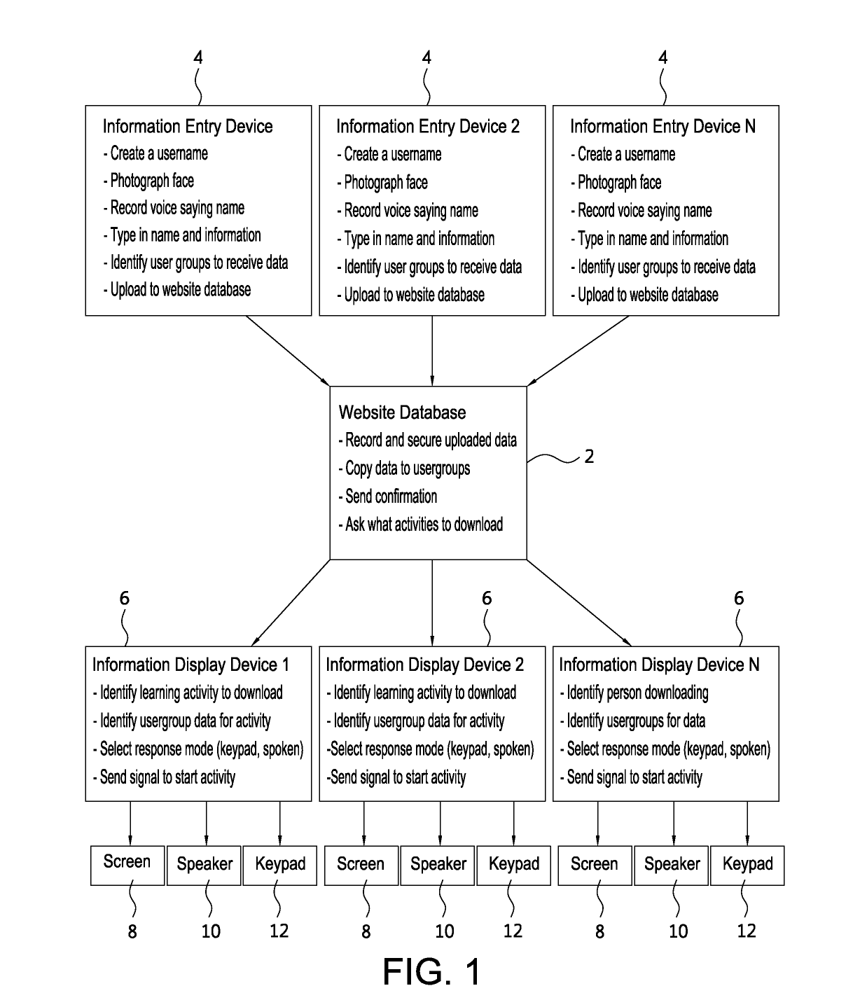

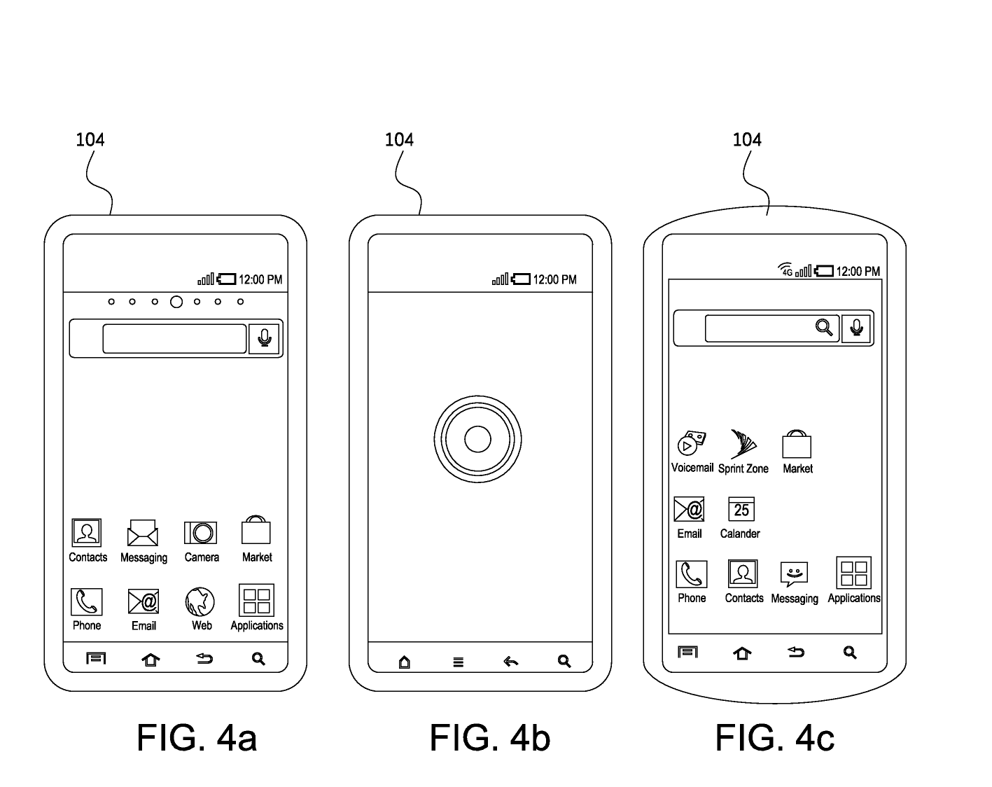

The present invention preferably utilizes a smartphone to collect, store and display information useful in learning the names of individuals. Referring to FIG. 1, a central database 2 has a plurality of information entry devices 4 connected therewith, either via a wireless network or the Internet. Suitable information entry devices include portable or desktop computers and tablets. According to a preferred embodiment, the information entry device comprises a smartphone 104 as shown in FIGS. 4a-c. Individuals, such as students in a classroom, use the smartphones or information entry devices 4 to enter a username, take a video motion photograph, state their name audibly, state their job or student status, state their home area and enter their first and last names electronically via a keypad on the smartphone. The visual, audio, and electronic information is entered or uploaded by the device into the database 2 and stored in a conventional manner, typically by username. The database 2 organizes the data by usergroups and sends a confirmation to the individual after the data has been uploaded. An example of a usergroup would be all of the students in a particular class or all of the customers at a store. Preferably, the data is secured such as by username and password protection so that only authorized individuals, such as authorized members of the usergroup, have access thereto.

Another user, such as a teacher for the class of a particular usergroup, can access the information in the database via one of a plurality of information display devices or terminals 6. Each device has a display screen 8, a speaker 10, and a keypad 12 connected therewith or incorporated therein. The user accesses the database by username and password and then identifies the learning activity to be downloaded or communicated from the database to the terminal. In addition, the user makes all data selections and responses via the terminals as will be discussed in greater detail below.

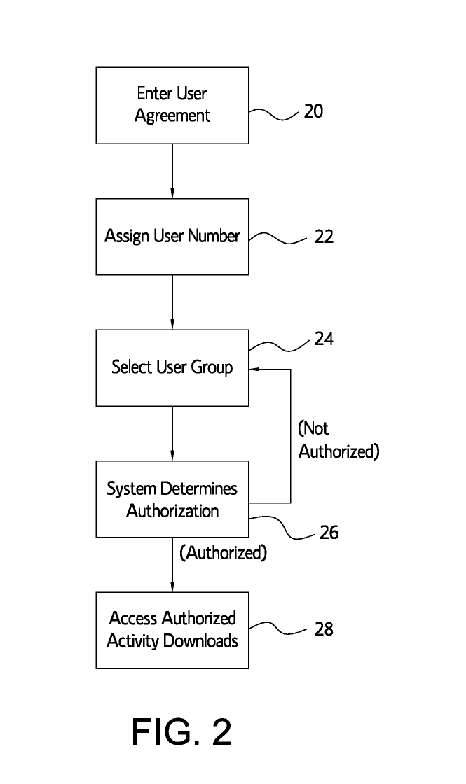

Referring to FIG. 2, the methodology for accessing the database will be described. A user enters the user agreement at step 20 from either an information entry device 2 or an information display device 6. The user is assigned a user number at step 22. The user then selects the appropriate user group at step 24. The system database determines whether the user is authorized at step 26 based on the prior entry of authorized user numbers. If the user is authorized, access to the database is permitted at step 28 and the user can enter information or access previously entered information as the case may be depending on the needs of the user. If the user is not authorized, access is denied and the user is offered another opportunity to enter the correct usergroup information.

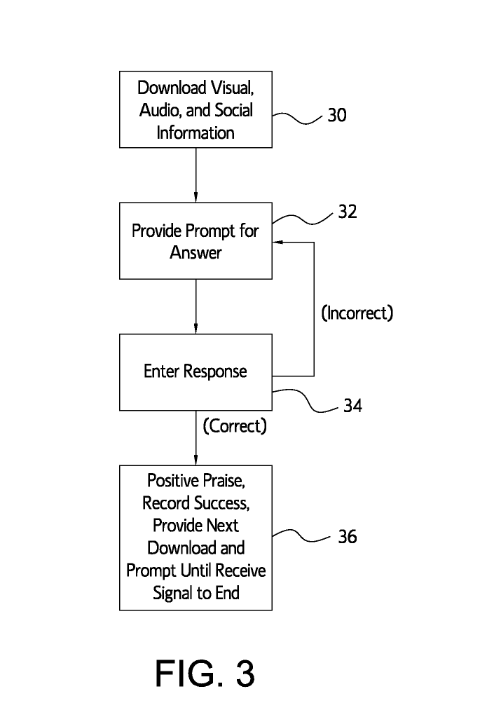

FIG. 3 is a flow diagram showing the steps according to a preferred method for assisting a first individual with learning names of other individuals. First, information relating to the other individuals is stored, such as in a database at step 30. The stored information may be audio and/or visual information including the name, voice, photograph, and video of the other individuals, and also social information for the individuals. The information may be transmitted via a wired or wireless network or uploaded via an electronic communication network such as the Internet into a secure database. The information is preferably stored in a secure environment and access to the database is password protected as set forth above. The first individual accesses the database which provides a prompt for the first individual to answer at step 32. For example, if a teacher is trying to learn the name of a student, the teacher accesses the database which displays a photograph of the student and then provides a list of names for the teacher to select. The teacher enters a response at step 34 by selecting one of the names which the teacher believes corresponds to the photograph. Next, at step 36, an indication whether the response is correct is provided. If the teacher selects the correct name, a positive audio and/or visual praise response is provided. If the response is not correct, a further increment of information such as the voice of the individual to be identified, is provided by repeating step 32. The remaining steps 34 and 36 follow in sequence. Steps 32, 34 and 36 are repeated until the teacher enters the correct response by properly identifying the student. For each repetition, a further increment of information relating to the individual to be identified is provided.

The invention can be applied to many different social situations, examples of which are set forth below.

### EXAMPLE 1

A new individual, for example the teacher of the class, a recently hired staff person or a parent bringing their child to be a new school, is informed of the smartphone process for taking a facial photograph or video, recording their voice and typing in their name with some social information. The name learning system is easily demonstrated and the system security is explained. The school parent or customer would clearly understand that their photo or their child's photo, video, voice recording, and social information could only be accessed and learned by the school staff. A short demonstration of the uploading and downloading of example information would show that a user must have a username, a group name, and a license name in order to have access to the photo, voice, and name learning activities. To receive these passwords and be added to the information subset, a person is required to show their identity and sign a legal agreement with the license holding organization or person.

If the customer or parent of a student is comfortable with the trial use of the system, the staff member takes a video recording of their face and records the person saying their name, and some social information (job title, home location, specific interest in foods, clothing, or school activities). Then the staff member types in the student's name with the school name and class name that the facial video recording would be stored in. If a customer or parent of a student is not comfortable with the voiced information of the smartphone motion video process, they would be given a brochure with a full program description. The brochure explains how their video recorded photograph, voice recording and printed information would be uploaded to the secure website and used by the staff in learning activities which help the staff to say the student's name when welcoming them to school or when asking a question in a classroom exercise. The learning activities make it easy for the staff to learn names and personal preferences that would allow the staff to be much more helpful in future interactions with the customer or school parent.

If the new customer wants some direct experience of the website information system, a staff person downloads the staff user group information in a learning activity. The customer would have direct experience of how the staff person's facial photo, voice recording and name with text information would be presented in ways to help the customer learn to recognize the staff members by name and be able to talk face to face with a more comfortable and useful quality.

If the customer would like to know other customers, then the staff person would explain how the customer could release their information and gain information relating to the other customers who want to know other customers. The use of a customer information pool only requires that the customer enter their permission for other customers to access their information. They are then given the effective password to download the customer to customer usergroup. The customer or parent of a student easily learns the names and basic social information of the business or school staff and also learns about the other regular customers and the other parents of students at the school. This allows the person to decide how much they want their interaction with the business or school to be more of a personal process or more of a community process with open communication with most of the people who are there.

### EXAMPLE 2

By way of example, if a general clothing and home supply business wants repeat customers to feel more comfortable, they could offer the website information service to help the customer service staff know their name and special product interests. Customers are offered the website passwords to learn the names and job titles of the service staff. If the business is a small, local business or restaurant/bar where the customers may have a desire to know the other customers, the customers are offered the opportunity to provide permission and receive access to the information relating to the other customers. This is provided in a store that wants its customer service staff to know the names and interests of repeat customers. When sales people know the names and previous product preferences of repeat customers, then they can say “Hello Ms. Smith. Are you interested in some more winter clothes or what else can I help you with?”

### EXAMPLE 3

In a further example, a school system purchases a license and each school in the system has its own “groupname” for all staff adults, students, and parents who wish to participate. An increase in the number of staff knowing the names of the school students results in improved learning and a decrease in misconduct by the students. If students show a good behavior record and if their parents approve, the students are given a specific version of the school “groupname” that allows them to download activities from the website to learn the names of the other students in their class or a “groupname” that would allow them to learn the names of all the students and adult staff in their whole school.

### EXAMPLE 4

If there is no large business or organization providing the technology, individuals or smaller organizations are invited to consider creating a user group in the computer information system. For example, people living in a neighborhood, members of a church, or employees and frequent customers of a restaurant could be more comfortable and mutually supportive if they could easily learn the names and social positions of other people. The computer technology would make it easy and entertaining to learn the names, jobs and home locations of the other people. A license is purchased by the initiating person or organization at minimal cost. The license specifies whether the initiating person or organization pays for all uses of the website under a specific “groupname” (“StAndrewsCatholic”, “3rdStreetBarandGrill”).

A staff person offers to show the customer or student's parents how a computer phone or a laptop can be used to take a facial photo of the staff person, record them saying their name, and type in some social information. Then the staff person contacts the website and shows that the person's information is stored in the user database. Lastly, the staff person shows how some information about another customer or student is used by the staff or the other users (customers, students) in the name and social information learning activities.

### EXAMPLE 5

New prospective users go to the website and enter the usergroup name and password. The website would then provide quick demonstrations of the software. The collection of information, uploading of information, and downloading of learning activities is displayed. If the user desires to join the usergroup, the person enters their choice for their personal username and their personal password which will then afford protection for their information. If the website visitors are comfortable with the system security, they upload their own name and information for others to learn. The information can be uploaded for a relatively short time (one month) or permanently, with knowledge that their information could be cancelled at anytime. The information would not be put into other usergroups without the personal request of the visitor. However, a person could easily copy their photo, their voice recording, and their personal information to other usergroups, as they have an opportunity to do so by the licensed organization or the person having a personal license. The system does not record any information (telephone number, email address, street address) that could be used to interfere with their other electronic or paper communications.

### EXAMPLE 6

The information processing system for practicing the invention is located in an easy to use website without risk of hacking and misuse of information. Individuals go to the website and view demonstrations of different ways of using the system software. Individuals can create a user defined group based on a community or neighborhood name and then try to promote the use of that “usergroup” by other people in the community. In these situations a small city or a neighborhood of a big city could promote more citizen communication and citizen connection by encouraging community members to join their usergroup. Each member pays their personal license fee for using the information system, but gains access to all new users without any expense. Each individual contributes their facial photo, voiced name recording, and text entry of name and social information. Each member of the usergroup receives small notices when there are new group members to learn. Then all the participating citizens could learn each other's names and some information about what kind of work they do or what neighborhood they live in. They could have comfortable discussions at the local park, a bus stop or on the subway going into the city. Many citizens would enjoy being able to name and say hello to some of the people who they see in the stores or in the local park.

### EXAMPLE 7

Organizations that want to make the system incorporating the invention available to groups of people (e.g., customers and sales staff or teachers and students) purchase a license which pays for the password entrance and membership into the organization's usergroup at the website. The organization purchases brochures and recorded training programs which explain and demonstrate the system techniques for inviting people to try the social learning activities. Waiters and waitresses of a restaurant are photographed, voice recorded and name entered in the system, so that customers could be shown the name/social learning activities of the staff usergroup. Then the customers consider if they would like to be in the restaurant customer user group, with their information being available to staff alone or to staff and to other customers. If the restaurant was a somewhat small neighborhood bar and grill, then many of the customers might want to get to know the other repeat customers. The licensed individuals or organizations can offer the use of the website to people by giving the people the password and code name of their licensed usergroup.

In learning anything complex like names and social information, it is important to combine the essential visual, auditory and conceptual information in brief, easily repeated instruction routines. A repeated visual display of a facial photograph with the audio projection of the person saying their name encourages the learner to say the name when the facial photograph is shown alone with a visual and/or auditory question of “Who is this person?” The learner has a list of names with touch screen buttons or the learner just says the name aloud for audio recognition. If the name is correctly indicated, then the name learner should receive praise and celebration with data of successes being recorded to see progress over time. Brief reviews of success in learning are very motivating for the learners and reassuring for the large organizations that pay for the licenses for adult staff or students to use the name and identity games.

This invention is an application of the smartphone computer technology to the wide spread problem of learning the names and social identity of people in schools, customer service businesses, and other organizations (country clubs, churches, etc.). Obviously, the visual and auditory stimulation has reached a high level in very easy to carry computer phone devices. Such computer telephone devices, or smartphones, have built-in cameras, microphones, video screens and keyboards that can easily capture, store, and retrieve the name and social information of people. When convenient, the user uses their computer phone to download instructional software and groups of personal information with which to play very stimulating, enjoyable and effective exercises. These exercises help them learn the names and social information in response to seeing their face photograph, their printed name and social information and the audio recording of the person saying their name.

This invention is based on a secure website with an attached server that is encrypted. Many security qualities are present in the website, so that names and personal information uploaded to the server are safe from any violation or misuse. The website server is expandable as the number of invention users increases. Large organizations may purchase licenses so that interested members of their staff may go to the website, enter a personally unique “username” and enter the organization “licensename”. If the username and licensename are acceptable to the server, then the user would be sent information on how they can join a “User Group”. This User Group membership requires them to send a signal of acceptance of the “User Agreement.” The User Agreement states that the name and identity information in the website would not be copied or otherwise used beyond the approved “User Games”. Upon the website receipt of the signed User Agreement, the User is officially acknowledged as a person who can access the information in certain User Groups within the licensed organization. The User submits a “usernumber” that is their personal basis of licensed, authentic membership in the User Group with access to the user information contained in that User Group database. Large organizations (school systems, consumer store chains, etc.) may have many User Groups within their license limits and the organizations would set their limits on users having access to their various User Groups. Some Users (teachers, business owners, etc.) may want to have access to the individual information files of all members of the User Groups, but restrict how many User Group members may have access to their personal User information file.

The website records the user's “username” and the user records a request to join specific User Groups. By joining a User Group, the user's information is entered into that dataset so that all group users can learn each other's names and identities. A “password” is provided for the user to access the User Group information in order to play the name and identity games to have entertaining ways to easily learn names and identity information for social benefit. If the licensed organization staff obtains a totally free “User” status, then they will be more likely to explore what activities the Users can do with the website software and the User Groups. Licensed organizations would be encouraged to establish an employee User Group, so that all employees could learn each other's name and also learn the names of the higher organizational staff members. Some supporting organizations request the person to provide a regular email address for receiving advertising or educational materials. Some federal or state grants are available to provide schools or government agencies with the website support for the teachers to easily learn the names and home locations of students and for military commanders to learn the names and ranks of their new recruits.

If the main organization involved with the social interaction of the people involved does not want to purchase a permanent license with the organization, then the organization encourages their customers, their country club members or other potential Users to obtain a personal license membership with the organization at a minimal cost. In this situation, the organization encourages customers to upload facial photographs, voice recordings of them saying their names, and some social information to the website and get a “username” and “usernumber” to freely access the personally licensed Users. For example, a person who frequently goes to a restaurant that is convenient and enjoyable may be very interested in becoming a User of the restaurant's User Group for service staff and customers. The customer could easily see, learn and rehearse the names and social information of the staff and other frequent customers. Then the customer is able to easily talk with the restaurant staff and with the other customers. The expense of the organization and individual users is shared in a convenient and reasonable manner. A country club might offer a free first year of User status in their User Group, in order to make it very easy for the club staff and the preceding club members to quickly get to know the new country club member. The continued User license after the first year would be included in their ongoing membership expense.

This invention allows easy access to student, customer and co-worker name and social information. The multi-sensory presentation of the information to be learned and the easy response to the quick questions allows an effective and enjoyable way to learn the name and social information. The cell phone computer devices can be used in the car driving to work, on lunch breaks, or when doing work around the home. Then teachers will be able to say “Good Morning, Bobby! How do you like fifth grade?” Customer service staff will be able to say “Nice to see you, Ms. Brown. Do you want some breakfast or just coffee?” Business administrators might meet a co-worker in an elevator and say “Hello Mr. Smith. How is the Legal Services Division doing today?” With these signals of being known by name and personal status, people are likely to feel comfortable and appreciated by the other people in the environment.

While the preferred forms and embodiments of the invention have been illustrated and described, it will be apparent to those of ordinary skill in the art that various changes and modifications may be made without deviating from the inventive concepts set forth above.

What is claimed is:

1. A vivid multi-sensory method for assisting a first individual with learning names of other individuals, comprising the steps of
(a) storing motion picture face and voice information of other individuals in a database;
(b) providing a brief presentation of stored information to the first individual;
(c) prompting the first individual to identify a selected individual from the other individuals; and
(d) providing an indication whether the first individual correctly identifies the selected individual.

2. A method as defined in claim 1, wherein said stored information is at least one of audio and visual information.

3. A method as defined in claim 2, wherein said stored information comprises at least one of the name, voice, and photograph of the other individuals.

4. A method as defined in claim 3, wherein said information is stored in a database via a wired or wireless communication system.

5. A method as defined in claim 4, wherein said information if provided to the first individual via a wired or wireless communication system.

6. A method as defined in claim 5, wherein said information is stored in a secured environment.

7. A method as defined in claim 6, wherein access to said database is via a password protected electronic network.

8. A method as defined in claim 2, wherein said indication providing step comprises a positive indication for a correct response.

9. A method as defined in claim 8, wherein said positive feedback indication comprises at least one of audio and visual praise.

10. A method as defined in claim 2, wherein said information providing step is repeated with a different increment of stored information when the first individual incorrectly identifies the selected individual.

11. A method as defined in claim 10, wherein said prompting and indication providing steps are repeated when said information providing step is repeated in response to an incorrect identification by the first individual.

12. A method as defined in claim 11, wherein said information providing, prompting and indication providing steps are repeated until the first individual correctly identifies the selected individual.
